(19) United States
(12) Patent Application Publication
(10) Pub. No.: US 2005/0178519 A1
(43) Pub. Date: Aug. 18, 2005

(54) Aluminium sulphate compositions containing polynuclear complexes and a method of producing the same and the use thereof

(76) Inventor: Stefan Jafverstrom, Norrkoping (SE)

Correspondence Address: Matthew E. Connors, Esq.;Gauthier & Connors LLP, Suite 3300, 225 Franklin Street, Boston, MA, 02110, US

(21) Appl. No.: 11/108,593

(22) Filed: Apr. 18, 2005

Related U.S. Application Data
(63) Continuation of application No. 10/793,250, filed on Mar. 4, 2004, now abandoned.
Application No. 10/793,250 is a continuation of application No. PCT/SE03/01143, filed on Jul. 9, 2002.

(30) Foreign Application Priority Data
Jul. 9, 2002 (SE) 0202146-7

(51) Int. Cl. C11D 17/00

(52) U.S. Cl. 162/903

(57) ABSTRACT

The present invention relates to a metal sulphate composition comprising a polynucleate metal sulphate having the general formulae [Me(OH)ₓ(SO₄)_{y}(H₂O)_{z}]n where Me is three valence metal ion of the group aluminium and iron n is an integer x is 1.0-2.8; y is 0.1-1.0; x+2y is 3 and z is 1.5-4, z being <4 when the product is in solid form and z being >4 when the product is in solution whereby it has a content of MG²⁺, its pH is at least 3.3 and at most 5.0 in liquid form, it has a basicity of at most 2.8, and it contains highly charged cationic polyaluminium complexes, as well as a method for its manufacture, and its use.

### TECHNICAL FIELD

The present invention relates to aluminium sulphate compositions for use in such processes as the purification of water, the manufacture of paper, and the dewatering of sludge, and specifically to compositions a prolonged shelf life. The invention also relates to a method for producing said aluminium sulphate compositions and the use thereof and finally to a process of purifying water, sizing paper, dewatering sludge and the like.

### BACKGROUND OF THE INVENTION

Aluminium sulphate, hereinafter referred to as ALS, for the purification of raw water and and sewage water and the sizing of paper normally has a composition which in solid state can be described approximately as Al₂(SO₄)₃×14H₂O. The sulphate content is slightly less than that which the formula states. The aluminium content is 9.1% in solid state.

When dissolving ALS in water, the solution is acid (pH 0-1 in concentrated solution) owing to the fact that the aluminium ions are hydrolyzed.

The pH-value of the solutions decreases with increasing ALS-concentration. The pH of an aluminium sulphate solution, thus prepared, can be raised, by adding alkali in the form of, e.g., alkali metal hydroxide, ammonia or calcium hydroxide.

By adding said alkali poly-nuclear aluminium complexes are formed. However, when an aluminium sulphate solution prepared by dissolving aluminium sulphate and having a pH of 0 to 1, is alkalized, the amount of poly-nuclear complexes in the solution will increase.

It is also known that aluminium sulphate solutions can be more effectively utilized when the pH of a relevant solution is adjusted to a pH range such that the solution will contain substantial amounts poly-nuclear complexes.

It is, however, also known that complexes based on aluminium sulphate are unstable and a primarily clear solution of such poly aluminium sulphate complex will become opaque soon after preparation thereof. Different attempts have been made to stabilize such solutions, including use of organic stabilizing agents.

A number of aluminium products are known which contain polynucleate aluminium ions in solution. These products have been developed as a result of the demand for more effective chemicals, for example for water purifying, paper sizing and sludge dewatering processes. Because of the high positive charge of the poly metal ions, the properties exhibited by the polynucleate products are far superior, when used within the aforementioned technical fields, than the mononucleate compounds previously used. The aluminium products developed with the aim of improving efficiency in the aforementioned fields of use are principally of two different kinds, namely chloride-based basic Al-compounds and sulphate-based basic Al-compounds. Of the first mentioned group there was first developed a polyaluminium chloride (PAC) of the general formula
[AlClₓ(OH)₃₋ₓ]ₙ
where x is <3 normally 1-2.

These compounds and their manufacture are described in, for example, SE-B-7201333-7, SE-B-7405237-4, SE-B-7412965-1, SE-B-7503641-8 and DE-A-2,630,768. A common feature of these aluminium-chloride containing compositions of the PAC-type based on polynucleate complexes is that the methods required to produce solutions which are effective, i. a., in purifying water, are extremely complicated, and consequently the cost of the solutions is relatively high vis-a-vis the effect obtained.

A second type of aluminium-chloride solutions, which are also based on the same polynucleate complexes have general summary formula, which can be written as
[Al(OH)ₓCl₃₋ₓ]ₙ+n.xMe(I)Cl
where Me(I) is an alkali metal, and
[Al(OH)ₓCl₃₋ₓ]ₙ+n.x/2 Me(II)Cl₂
where Me(II) is an alkali earth-metal, n is a positive integer and x is an integer in the range 1-2.7.

Polynucleate aluminium-chloride solutions of the second type are described in FR-A1-2308594 (=DE-A1-2,617,282; U.S. Pat. No. 4,051,028), according to which the solutions are prepared by alkalising aluminium-chloride solutions with solutions of alkali hydroxide. According to this reference, however, it is not possible to produce clear, stable solutions other than when preparing highly diluted solutions. By “stable solution” is meant here and in the following a solution whose composition and properties will not change when the solution is stored for a long period of time. For example, it is stated in the aforementioned reference that, under special conditions, there can be obtained a solution with up to 0.40 moles Al per litre. This solution, which has a highly limited stability, must be injected directly into the water to be purified. It is clearly evident from the publication, and in particular from the working examples therein, that solutions where the aluminium concentration Is higher, than about 0.1 mole/l cannot be expected to be effective and stable with the solutions known according to the publication.

The first mentioned type of aluminium product (PAC) is particularly expensive to produce, due to the complicated manufacturing procedures required. The second type of aluminium product can be produced more cheaply, but is less effective.

In SE-C-7903250-4 (publ. No. 419 212) a process for the production of standard aluminium sulphate qualities is described, whereby aluminium hydroxide or bauxite is digested in a sulphuric acid aqueous solution, whereby, in order to eliminate frothing problems during the digestion, air is blown through the reaction vessel.

Sulphate-based basic Al-compounds are described in EP-A-0 005 419, EP-A-0 017 634 and SE-A-8101830-1.

These products contain, to a greater or lesser extent, polynucleate metal ions in solutions, and are thus an effective water-purifying agent. The sulphate-based products can also be used for purposes other than purifying water, since the presence of the polynucleate metal ions enables desired effects to be achieved,

Such applications include, for example, the sizing of paper in paper-manufacturing processes, in which an aluminium sulphate and a resin adhesive are added to the stock, the adhesive being fixed to the fibres, with the aid of the aluminium sulphate. In this respect, it has been found that polynucleate sulphate-based Al-compounds are superior to mononucleate Al-sulphate.

Polynucleate sulphate-based Al-compounds are also excellent retention agents, i.e. agents, which increase the amount of solid material retained on a paper web, i.e. such material as filling agents and fibres. In certain cases, however, it is desirable, and also necessary, to limit the supply of sulphate ions as far as possible in applications within the aforementioned fields of use, and particularly when purifying drinking water. This is of particular importance in systems, which are used and cleansed a repeated number of times, to eliminate the risk of sulphate accumulating in body tissues and, from the aspect of concrete corrosion, in the water. For example, this applies to certain water-purifying systems where water is a scarce commodity, necessitating the water to be used for as long as possible between intermediate purifying operations. After purifying such water 10 times with conventional Al-sulphate or compositions with corresponding sulphate contents, the sulphate content of the water will be so great that the water will cause corrosion problems. The problems arising from the enrichment of sulphate ions are now also prevalent in the manufacture of paper, where for environmental reasons the water-conveying system is, to a great extent, closed. The manufacturing processes are seriously affected when the amount of salts contained in the paper stock are excessively high.

The chloride-based Al-compositions exhibit a number of disadvantages in relation to the sulphate-based compositions, of which the most serious are the higher costs of purifying the water. Because of the corrosion risks involved, the chloride-based aluminium compounds are not so well suited for use in paper manufacturing processes.

The U.S. Pat. No. 4,238,347 describes products with lower sulphate contents. These products could represent an attractive alternative to the afore-described sulphate-based Al-compounds when the sulphate content constitutes a problem after treatment, provided that the solutions contain sufficient polynucleates to produce a comparable result. The products, however, have an OH/Al-ratio of up to only 1.5, restricted to 1.3 for practical use. This means that the product has far less polynucleates than, for example, the sulphate-based product described in SE-A-8101830-1, mentioned above, and is thus less effective than said product, which means that higher quantities must be added and that the use of said product is more expensive and does not reduce the sulphate content to the same extent.

In SE-A-8104149-3 there is described an improved method for producing sulphate-poor polynucleate aluminium hydroxide complexes of the formula
[Al(OH)ₓ(SO₄)_{y}(H₂O)_{z}]ₙ
where
n is an integer
x is 0.75-2.0;
y is 0.5-1.12;
x+2y is 3 and
z is 1.5-4, z being ≦4 when the product is in solid form and z being >>4 when the product is in solution, the aluminium sulphate being admixed with one or more of the compounds from the group CaO, Ca(OH)₂, BaO, Ba(OH)₂, SrO, Sr(OH)₂ in aqueous solution to the reaction to form the given compound, where after the resultant alkali earth metal sulphate precipitate is separated out and the residual solution optionally vaporised. The resultant solution, which can be obtained with a high basicity, OH/Al ≦2.0, has splendid properties, but the manufacture of the solution results in a waste, the alkali earth metal sulphate, which is undesirable, since it constitutes up to 30% of the reaction mixture at a basicity of 2.0. A search has therefore been made for other methods which give no waste or which yield a residual product, which has its own market value.

EP-A-0 110 847 relates to a method for producing sulphate poor, polynucleate aluminium hydroxide sulphate complexes of the general formula
[Al(OH)ₓ(SO₄)_{y}(H₂O)_{z}]ₙ
in which
n is an integer
x is 1.5 to 2.0
y is 0.5 to 0.75
x+2y is 3
z is greater than 4
   which comprises: neutralising a solution consisting essentially of an aluminium salt of a strong acid to a pH of 5 to 7 with an alkali hydroxide to precipitate amorphous aluminium hydroxide, separating the precipitated amorphous aluminium hydroxide from the solution, and reacting the precipitated aluminium hydroxide while it is still in an amorphous form with aluminium sulphate, sulphuric acid or a mixture thereof in an amount such that y is 0.5 to 1.12 under conditions effective to form the polynucleate complexes in solution.

However, previously known and manufactured polynucleate aluminium sulphates of the type described in e.g., EP-A-0 110 847, are not stable as indicated above, but deteriorate within a short period of time such as from a few hours to some week. This is contrary to the polynucleate aluminium chlorides, which are all stable.

FR-A-2,563,513 discloses basic aluminium sulphates, which have been prepared by reacting a carbonate or a hydrogen carbonate of an alkali metal or ammonium, and an oxide, hydroxide or a carbonate of magnesium, whereby the complexes obtained have a basicity of 0.8 to 1.5, experimentally shown 1.03 to 1.38.

Thus there has been an aim for years to obtain stable polynucleate aluminium sulphates, which have a prolonged shelf life, and can be transported and delivered under normal conditions.

### DESCRIPTION OF THE PRESENT INVENTION

It has now surprisingly been shown possible to solve this problem and to obtain stable polynucleate aluminium and/or ferric sulphate compositions comprising a polynucleate metal sulphate having the general formulae
[Me(OH)ₓ(SO₄)_{y}(H₂O)_{z}]ₙ
where Me is a three valence metal ion of the group aluminium and iron
n is an integer
x is 1.0-2.8;
y is 0.1-1.0;
x+2y is 3 and
z is 1.5-4, z being <4 when the product is in solid form and z being >4 when the product is in solution, whereby the compositions are characterized in that they have a content of Mg²⁺, its pH is at least 3.3 and at most 5.0 in liquid form, it has a basicity of at most 2.8, and it contains highly charged cationic polyaluminium complexes.

A preferred embodiment comprises a metal sulphate composition, wherein the polynucleate is an aluminium hydroxide complex of the formula
[Al(OH)ₓ(SO₄)_{y}(H₂O)_{z}]ₙ
where n is an integer
x is 1.0-2.8;
y is 0.1-1.0;
x+2y is 3 and
z is 1.5-4, z being <4 when the product is in solid form and z being >4 when the product is in solution, which composition is characterized in that it has a content of Mg²⁺, its pH is at least 3.3 and at most 5.0 in liquid form, it has a basicity of at most 2.5, and it contains highly charged cationic aluminium complexes.

Another preferred embodiment is a metal sulphate composition, wherein the polynucleate is an iron hydroxide complex of the formula
[Fe(OH)ₓ(SO₄)_{y}(H₂O)_{z}]ₙ
where n is an integer
x is 1.0-2.8;
y is 0.1-1.0;
x+2y is 3 and
z is 1.5-4, z being <4 when the product is in solid form and z being >4 when the product is in solution, which composition is characterized in that it has a content of Mg²⁺, its pH is at least 3.3 and at most 5.0 in liquid form, it has a basicity of at most 2.5, and it contains highly charged cationic polyaluminium complexes.

A further preferred embodiment of the invention is a metal sulphate composition, wherein the polynucleate is an aluminium-iron hydroxide complex of the formula
[AlₐFe₁₋ₐ(OH)ₓ(SO₄)_{y}(H₂O)_{z}]ₙ
where n is an integer
x is 1.0-2.8;
y is 0.1-1.0;
x+2y is 3 and
z is 1.5-4, z being <4 when the product is in solid form and z being >4 when the product is in solution, which is characterized in that it has a content of Mg²⁺, its pH is at least 3.3 and at most 5.0 in liquid form, it has a basicity of at most 2.5, and it contains highly charged cationic polyaluminium complexes.

Another preferred embodiment of the invention is a metal sulphate composition, wherein pH is 3.7 to 4.5, more preferably 3.8 to 4.3 in liquid form.

A still further preferred embodiment of the invention is a metal sulphate composition, wherein the amount of Mg²⁺ is stoichiometrically equivalent to the basicity?

A further preferred embodiment of the invention is a metal sulphate composition, wherein the aluminium content expressed as Al is at least 2.6%, more preferably at least 3.4%, still more preferably at least 5.8 to 8.0%.

In accordance with a further aspect of the invention a metal sulphate composition as given above, is used in such processes as the purifying of water, the manufacture of paper and the dewatering of sludge and the like.

Another aspect of the invention concerns the manufacture of the polynucleate metal sulphates and thus relates to a method of producing the compositions of above, which method comprises mixing aluminium and/or ferric sulphate in water to provide a concentration of between 0.05 and 1.5 moles of metal per litre, adding Mg²⁺ in the form of its oxide, carbonate or hydroxide in an amount corresponding to the amount of hydroxide ions needed to provide for a basicity of at least 1.0, providing a first solution to be used as such or be further treated.

If for example Mg(OH)₂ is used the product is formed the following way:
Al(SO₄)_{1,5}+n.x/2 Mg(OH)₂→[Al(OH)ₓ(SO₄)(_{3-x)/2}]ₙ+n.x/2 MgSO4

In another preferred embodiment a first solution obtained is diluted using water allowing precipitation of an aluminium hydroxide compound, recovering the aluminium hydroxide compound thus precipitated, and dissolving said aluminium hydroxide compound in a further first solution, or an aluminium sulphate solution, a crystalline aluminium sulphate, or another aluminium polynucleate solution to increase the amount of aluminium in a resulting solution. Such further aluminium salt solution can also be aluminium chloride or a polyaluminium chloride solution prepared in any conventional and known manner.

The aluminium hydroxide compound obtained is very reactive, and will readily react with the different types of aluminium compounds and compositions. The aluminium hydroxide compound precipitated has been found to be:
[Al(OH)_{(1.6-2.5)}(SO4)_{(0,64-0,30)}]ₙ,
where n can be as high 13.

The size of the particles of the aluminium hydroxide compound is 10 to 20 μm.

In a further preferred embodiment the reaction temperature is kept below 100° C., preferably below 50° C., more preferably below 40° C., and most preferably below 30° C. A minor addition of boric acid is improving the stability of the solution, especially at reaction temperature in the higher range.

The present compositions can be used in water purification, either tap water production or purification of sewage water.

Further the compositions can be used in dewatering of sludge and the like whereby the polynucleate reduces the water binding capacity of such sludge and plant material.

In a further aspect the compositions can be used in paper manufacturing processes, such a paper sizing, paper fibre retention, and as a fixing agent, and may even be used as a filler as such, as the aluminium hydroxide compound formed by dilution to a more neutral pH will precipitate onto the fibres and thus become a filler. Hereby, as the precipitate is cationic charged, it can easily replace complex additives at paper manufacture, such as silicate based ones containing additives which are anionic and where different steps have to be taken to change the charge on the surface of the fibre to be treated and as treated.

The basicity of the polynucleate is of importance for the efficiency and performance of the product, and there is a desire to keep the basicity as high as possible. Basicity is sometimes expressed as the ratio between OH and Al (OH/Al) or Fe (OH/Fe) and sometimes-as percentage. The following table provides a number of ratios and corresponding percentages as well as x and y of the formula [Me(OH)ₓ(SO₄)_{y}(H₂O)_{z}]ₙ:

| Ratio OH/Al | Percentage % | x | y |
|---|---|---|---|
| 0.2 | 6.66 | 0.2 | 1.4 |
| 0.3 | 10 | 0.3 | 1.35 |
| 0.4 | 13.3 | 0.4 | 1.3 |
| 0.6 | 20 | 0.6 | 1.2 |
| 0.8 | 26.7 | 0.8 | 1.1 |
| 0.9 | 30 | 0.9 | 1.05 |
| 1.0 | 33 | 1.0 | 1.0 |
| 1.2 | 40 | 1.2 | 0.9 |
| 1.4 | 46.67 | 1.4 | 0.8 |
| 1.5 | 50 | 1.5 | 0.75 |
| 1.6 | 53.5 | 1.6 | 0.7 |
| 1.8 | 60 | 1.8 | 0.6 |
| 2.0 | 66.6 | 2.0 | 0.5 |
| 2.1 | 70 | 2.1 | 0.45 |
| 2.4 | 80 | 2.4 | 0.3 |
| 2.5 | 83.3 | 2.5 | 0.25 |
| 2.7 | 90 | 2.7 | 0.15 |
| 3.0 | 100 | 3.0 | 0 |

To show the efficiency of the new composition of the present invention a number of coaguiants were tested on the same water on the same mass dose basis.

The coagulants tested were:
(i) Aluminium sulphate, (4.2% Al).
(ii) Kemira PAX-XL-9, polyaluminium chloride, 4.5% Al, 70% basicity.
(iii) PAC, 4.8% Al, 45% bascicity.
(iv) Poly Aluminium sulphate acc. to the invention, 50% basicity.
(v) Poly Aluminium Iron sulphate acc. to the invention, 50% basicity.
(vi) PASS 100 (polyaluminium sulphate-silicate), 5.2% Al, 70% basicity.

Raw water characteristics

| | |
|---|---|
| pH | 6.45 |
| Colour (°Hazen) | 46.2 (Apparent)/28.8 (True) |
| Turbidity (NTU) | 3.8 |
| Transmittance at 254 nm) | 57.5 |
| Total dissolved solids (mg/l) | 21.8 |
| Alkalinity (mg/l CaCO3) | 15 |
| Hardness (mg/l CaCO3) | 10 |
| Natural Aluminium (mg/l | 0.00 |
| Natural Iron (mg/l) | 0.08 |

The water was kept refrigerated and held a temperature of 3° C. at the start of the testing.

Each coagulant was dosed at the following mass dose levels:
25, 30, 35, 40, 45, and 50 mg/l. Since the polyaluminium sulphate products could not be pre-diluted prior to use, all products were dosed in undiluted state.

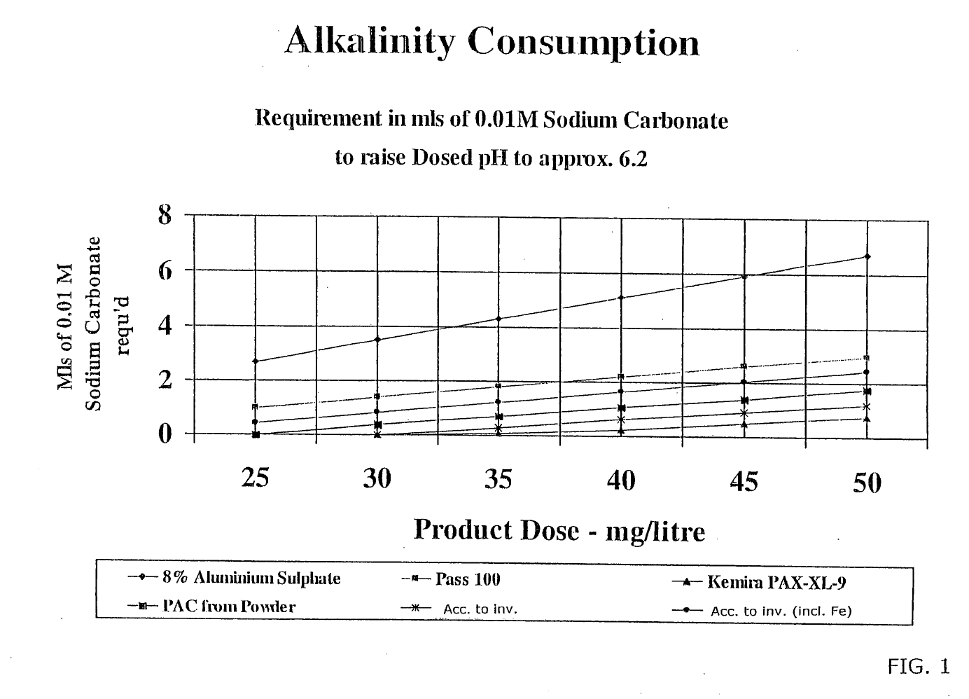

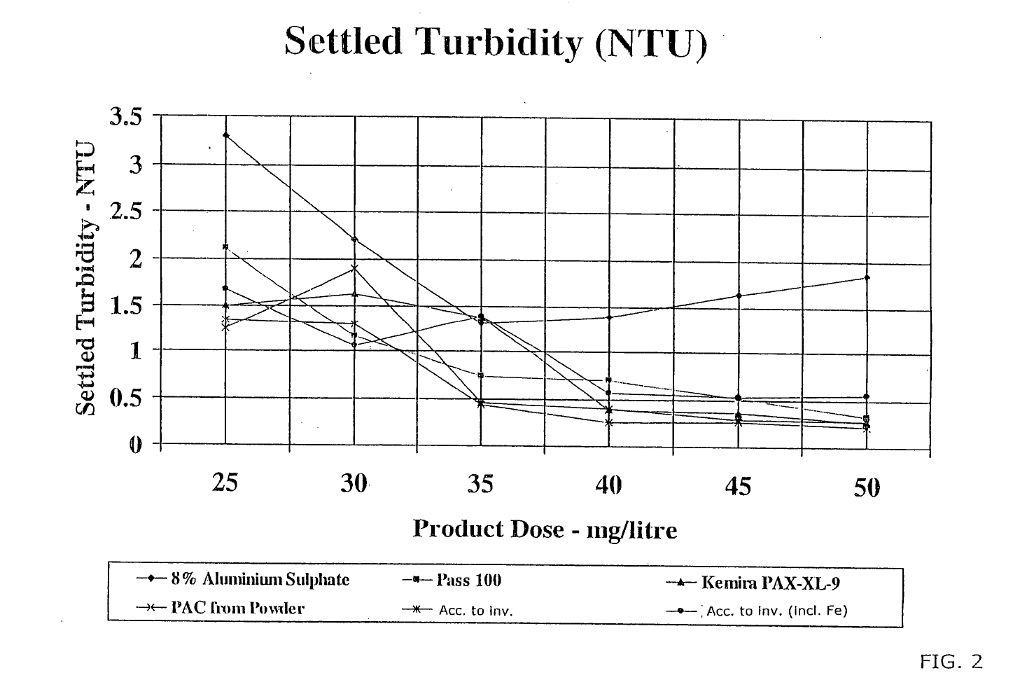

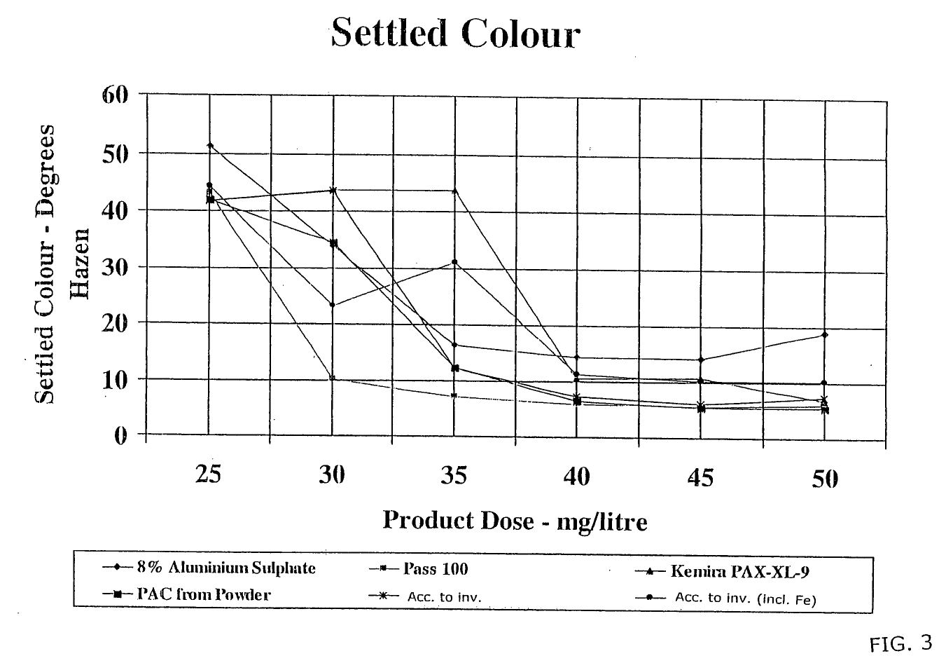

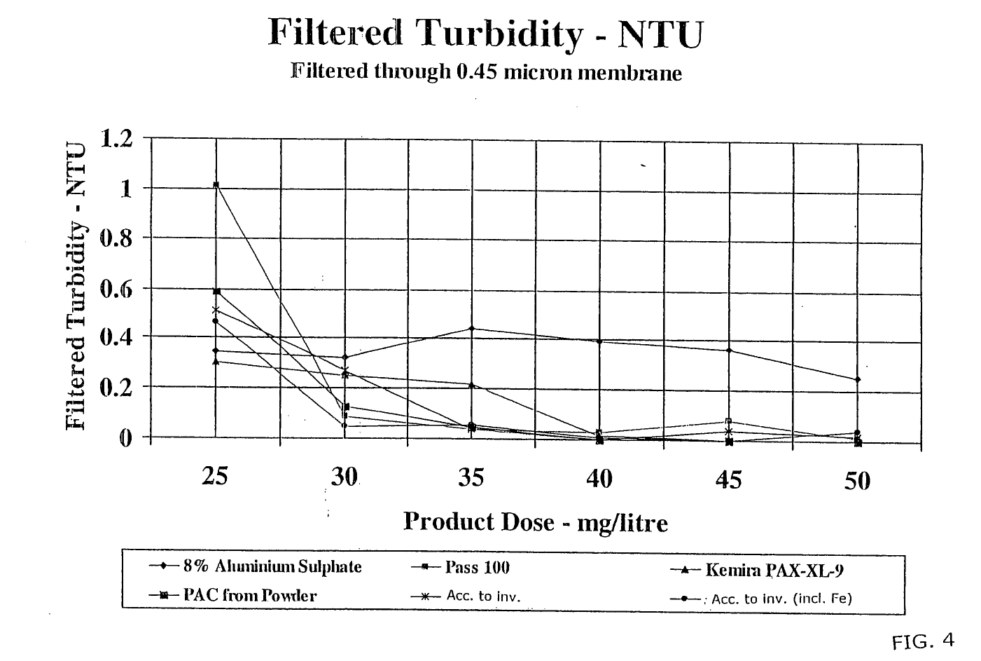

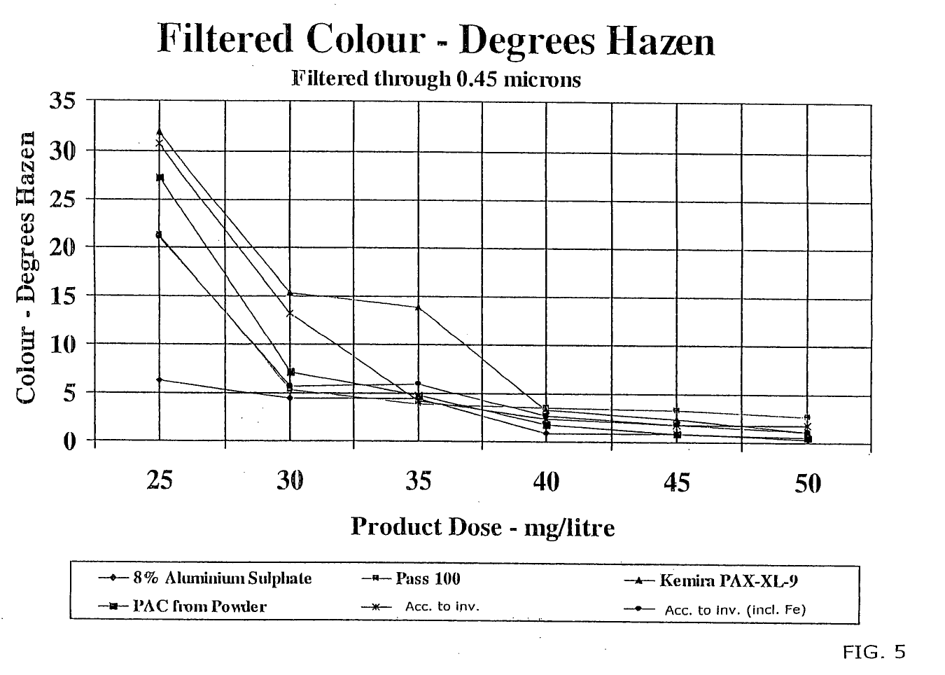

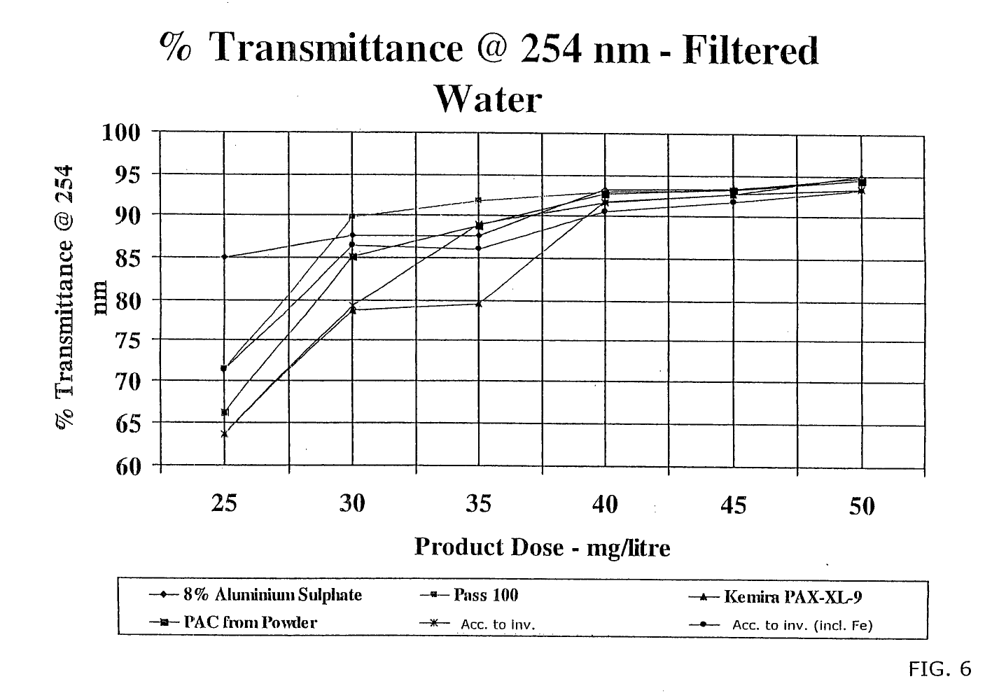

The results obtained checking for
Alkalinity Consumption, were the requirement in milliliter of 0.01 M sodium carbonate to raise pH at dosage to approx. pH 6.2 was determined (FIG. 1),
Settled Turbidity determined at each dose level for each product (FIG. 2),
Settled Colour determined at each dose level for each product (FIG. 3),
Filtered Turbidity determined after filtration through a 0.45 micron membrane at each dose level for each product (FIG. 4),
Filtered Colour ° Hazen determined after filtration through a 0.45 micron membrane at each dose level for each product (FIG. 5),
% Transmittance at 254 nm determined on filtered water (FIG. 6),

Levels of residual aluminium and iron in the filtered water were analysed in each case. (Table 1)

TABLE 1

| | | | | | | |
|---|---|---|---|---|---|---|
| Product | 25 mg/l | 30 mg/l | 35 mg/l | 40 mg/l | 45 mg/l | 50 mg/l |

Residual aluminium - mg/las Al at each dose level

| | | | | | | |
|---|---|---|---|---|---|---|
| (i) | 0.18 | 0.18 | 0.19 | 0.11 | 0.07 | 0.10 |
| Alumimium | | | | | | |
| sulfate | | | | | | |
| (ii) | 0.33 | 0.30 | 0.09 | 0.00 | 0.04 | 0.02 |
| PAX-XL-9 | | | | | | |
| (iii) | >0.5 | 0.18 | 0.14 | 0.10 | 0.09 | 0.10 |
| PAC | | | | | | |
| (vi) | >0.5 | 0.08 | 0.03 | 0.00 | 0.04 | 0.02 |
| PASS 100 | | | | | | |
| (v) | 0.48 | 0.15 | 0.14 | 0.12 | 0.07 | 0.09 |
| Polyaluminium | | | | | | |
| iron sulfate | | | | | | |
| (iv) | >0.5 | 0.28 | 0.08 | 0.07 | 0.07 | 0.05 |
| Polyaluminium | | | | | | |
| sulfate | | | | | | |

Residual iron - mg/las Fe at each dose level

| | | | | | | |
|---|---|---|---|---|---|---|
| (i) | 0.01 | 0.03 | 0.03 | 0.02 | 0.03 | 0.03 |
| Alumnium- | | | | | | |
| sulfate | | | | | | |
| (ii) | 0.06 | 0.03 | 0.04 | 0.06 | 0.04 | 0.04 |
| PAX-XL-9 | | | | | | |
| (iii) | 0.07 | 0.02 | 0.04 | 0.04 | 0.03 | 0.01 |
| PAC | | | | | | |
| (vi) | 0.03 | 0.00 | 0.00 | 0.00 | 0.00 | 0.01 |
| PASS 100 | | | | | | |
| (v) | 0.05 | 0.03 | 0.03 | 0.01 | 0.04 | 0.01 |
| Polyaluminium | | | | | | |
| iron | | | | | | |
| sulfate | | | | | | |
| (iv) | 0.06 | 0.03 | 0.03 | 0.05 | 0.03 | 0.03 |
| Polyaluminium | | | | | | |
| sulfate | | | | | | |

In a further test, water from Lake Bolmen was tested at the drinking water plant at Stehag, Sweden. Water from Lake Bolmen is used to provide a large part of the residents of the south of Sweden with drinking water.

The water was tested with regard to turbidity as well as with regard to pH as a function of dosage of Me³⁺(Al³⁺or Fe³⁺) in μg/l.

The products tested were
a) Polyaluminium sulfate in accordance with the present invention having 50% basicity.
b) Aluminium sulphate, 4.5% Al.
c) Iron chloride, FeCl₃
d) Pluspac, +PAC, a polyaluminium chloride neutralized using dolomite
   which were tested at the dose levels of Me³⁺(μmole/l) given in Table 2 and Table 3. These dose levels of Me³⁺ correspond to 25, 30, 35, 40, 45, and 50 mg/lof of solid aluminium sulfate (9.1% Al)

The results are given in the Tables 2 and 3 below.

TABLE 2
Turbidity (NTU) as a function of dosage

| Product | 84 μmole/l | 101 μmole/l | 118 μmol/l | 135 μmol/l | 152 μmol/l | 168 μmol/l |
|---|---|---|---|---|---|---|
| a) | 1.7 | 1.7 | 1.8 | 1.9 | 1.8 | 1.8 |
| Polyaluminium | | | | | | |
| sulfate | | | | | | |
| b) | 5.5 | 5.9 | 2.7 | 3.4 | 1.8 | 1.8 |
| Aluminium | | | | | | |
| sulfate | | | | | | |
| c) | n.d. | 6.5 | 4.2 | 3.3 | 6.2 | 9 |
| FeCl3 | | | | | | |
| d) | n.d. | n.d. | 0.5 | 0.5 | 0.8 | 5.0 |
| +PAC | | | | | | |

n.d. = not determined

TABLE 3
pH as a function of dosage

| Product | 0 μmol/l | 84 μmol/l | 101 μmol/l | 118 μmol/l | 135 μmol/l | 152 μmol/l | 168 μmol/l |
|---|---|---|---|---|---|---|---|
| a) | 6.8 | 6.7 | 6.7 | 6.7 | 6.7 | 6.7 | 6.7 |
| Polyaluminium | | | | | | | |
| sulfate | | | | | | | |
| b) | 6.8 | 6.3 | 6.2 | 6.1 | 5.8 | 5.6 | 5.5 |
| Aluminium | | | | | | | |
| sulfate | | | | | | | |
| c) | 6.8 | 6.0 | 5.8 | 5.5 | 4.9 | 4.5 | 4.3 |
| FeCl3 | | | | | | | |
| d) | 6.8 | 6.7 | 6.7 | 6.7 | 6.7 | 6.7 | 6.7 |
| +PAC | | | | | | | |

As evident from the two tables the product composition according to the present invention provides very low turbidity values, whereas the other compositions are more varied in their performance, as well as the composition of the present invention does not influence pH of the water treated to any greater extent. Taken as such the present composition is superior to those compared with.

The production of the composition will be described more in detail in the following with reference to a number of Examples.

### EXAMPLE 1

A slurry of magnesium oxide, 58 kg, in 104 kg of water was added to 838 kg of a solution of aluminium sulphate (4.2% Al) in a reactor. The mixture was allowed to react for 2 hrs during a moderate temperature increase to 50° C. When the reaction was finished the final solution was filtered to eliminate any solids present from the raw materials, to provide 1000 kg of polyaluminium hydroxide sulphate. The raw magnesium oxide contained 94% of MgO, 2.0% of CaO, 1.0% SiO₂ and 0.7% Fe₂O₃.

The magnesium oxide is added to the water to provide a slurry. The reason is that by dosing the alkali, MgO, in a slurry form it is easier to avoid any local reactions creating hard lumps of magnesium oxide coated with a layer of precipitated aluminium hydroxide.

The magnesium oxide slurry is added to the solution of aluminium sulphate over a time period of 10 to 15 min. The reaction generates some heat, approximately 20 to 40° C. increase depending on heat losses to the surroundings. The primary “milky” solution will clear-up over the time, approximately 2 hrs.

Insolubles like silica and iron oxide are easy to settle but the content of calcium sulphate, which will occur, depending on the CaO content of the MgO will take longer time, and for that reason the reaction solution is agitated for another 10 hrs.

The heavy solids are allowed to settle for 30 min whereupon, in order to save production time, filtration is carried out to eliminate the further solids present including calcium sulphate. The final solution is clear, transparent.

The final solution containing 3.6% of Al had a basicity (OH/Al) of 2.0 (67%) and had a pH of 3.7. The density was 1.27. The solution was stable for at least 5 months.

### EXAMPLE 2

100 kg of the solution of Example 1 were diluted 4 times using normal tap water whereby a precipitate of an aluminium hydroxide compound immediately occurred. The precipitate was filtered off, and was dissolved in another 100 kg of solution of Example 1. Thereby the amount of Al was increased to 6.6% Al, while maintaining the same basicity.

### EXAMPLE 3

100 kg of the solution of Example 1 were dried on a roller drier to provide a flaky non-hygroscopic material. The dried product was easily dissolved in water prior to use.

### EXAMPLE 4

838 kg aluminium sulphate solution (4.2% Al) was provided with 104 kg of water into which 58 kg of MgO had been slurried (163 kg of slurry having a dry substance content of 36%). The magnesium oxide slurry was added over a time period of 10 to 15 minutes, whereby the exothermic heat was not allowed to raise the temperature of the reaction mixture to above 35° C. Primary reaction time is 2 hrs. Primarily, at addition of the slurry the reaction mixture became “milky” but it cleared up within a few minutes. Due to the content of CaO of the MgO some gypsum was formed. The gypsum was removed by filtering the final solution after an after-reaction time of 5 hrs. The filter cake held, besides gypsum (3.6 kg), some silica and iron oxide, and the total filter cake amounted to 4.5 kg. The basicity of the final polynucleate aluminium sulphate solution is 70% (OH/Al=2.1), and it contains 3.5% of Al.

1. An aluminium sulphate composition comprising a polynucleate aluminium sulphate having the general formulae
[Al(OH)ₓ(SO₄)_{y}(H₂O)₂]ₙ
n is an integer
x is 1.0-2.8;
y is 0.1-1.0;x+3y is 3 and
z is 1.5-4, z being <4 when the product is in solid form and z being >4 when the product is in solution wherein it has a content of Mg²⁺, whereby the amount of Mg²⁺ is
stoichiometrically equivalent to the basicity, its pH is at least 3.3 and at most 5.0 in liquid form, it has a basicity of at most 2.8, and it contains highly charged cationic polyaluminium complexes.

2. A metal sulphate composition according to claim 1, wherein pH is 3.7 to 4.5 in liquid form.

3. A metal sulphate composition according to claim 2, wherein pH is 3.8 to 4.3 in liquid form.

4. A metal sulphate composition according to claim 1, wherein the aluminium content expressed as Al is at least 2.7%.

5. A metal sulphate composition according to claim 4, wherein the aluminium content expressed as Al is at least 3.4%.

6. A metal sulphate composition according to claim 5, wherein the aluminium content expressed as Al is at least 6.4%.

7. A metal sulphate composition according to claim 1, wherein a stability increasing amount of boric acid is present.

8. A method of producing the composition of claim 1, wherein mixing aluminium and/or ferric sulphate in water to provide a concentration of between 0.05 and 1.5 moles of metal per litre, adding Mg²⁺ in the form of its oxide, carbonate or hydroxide in an amount corresponding to the amount of ions needed to provide for a basicity of at least 1.0 OH/Al, providing a first solution to be used as such to be further treated.

9. A method according to claim 8, wherein a first solution obtained is diluted using water allowing precipitation of a highly reactive aluminium hydroxide compound and recovering the aluminium hydroxide compound thus precipitated.

10. A method according to claim 8, wherein the precipitated and recovered aluminium hydroxide compound is dissolved in a further first solution, or an aluminium sulphate solution, a crystalline aluminium sulphate, or another aluminium salt solution to increase the amount of aluminium in and the basicity of the resulting solution.

11. A method according to claim 8, wherein the reaction temperature is kept below 100° C.

12. A method according to claim 10, wherein the reaction temperature is kept below 30° C.

13. A method according to claim 1, wherein it further encompasses an addition of boric acid for further improving the stability of the solution, especially at reaction temperature in the higher range.

14. A method according to claim 9, wherein the concentration of aluminium expressed as Al is up to 8% in sulphate based solutions and up to 13% in chloride based solutions.

15. The use of a polynucleate metal composition according to claim 1, at the purification of water.

16. The use of a polynucleate metal composition according to claim 1, at the dewatering of sludge and the like.

17. The use of a polynucleate metal composition according to claim 1, at the manufacture of paper.

18. The use of a polynucleate metal composition according to claim 1, at the manufacture of paper as a sizing agent.

19. The use of a polynucleate metal composition according to claim 1, at the manufacture of paper, as a retention agent.

20. The use of a polynucleate metal composition according to claim 1, at the manufacture of paper as a fixing agent.

21. The use of a polynucleate metal composition according to claim 1, at the manufacture of paper as a filler agent.
